(19) United States
(12) Patent Application Publication
(10) Pub. No.: US 2021/0155843 A1
(43) Pub. Date: May 27, 2021

(54) ANTI-FOULING COMPOSITIONS FOR USE IN CRUDE OIL PRODUCTION AND PROCESSING

(71) Applicant: Ecolab USA Inc., St. Paul, MN (US)

(72) Inventors: Omer Gul, Rosenberg, TX (US); Janelle Leigh Pennington, Missouri City, TX (US)

(21) Appl. No.: 17/104,658

(22) Filed: Nov. 25, 2020

Related U.S. Application Data
(60) Provisional application No. 62/941,314, filed on Nov. 27, 2019.

(51) Int. Cl. C09K 8/524

(52) U.S. Cl. CPC C09K 8/524

(57) ABSTRACT

An anti-fouling composition has been developed that provides an advantageous reduction in the fouling of a structural part in a petroleum-refining system including inhibiting deposition of solids in equipment and lines used for crude oil production and processing. The anti-fouling compositions contain a phosphate ester and a polyalkylene ester.

### CROSS REFERENCE TO RELATED APPLICATIONS

This application claims priority to U.S. Provisional Patent Application Ser. No. 62/941,314 filed on Nov. 27, 2019, the disclosure of which is incorporated herein by reference in its entirety.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable

### REFERENCE TO A SEQUENCE LISTING, TABLE, OR COMPUTER PROGRAM LISTING APPENDIX SUBMITTED ON A COMPACT DISC AND AN INCORPORATION-BY-REFERENCE OF THE MATERIAL ON A COMPACT DISC

Not applicable.

### FIELD OF THE INVENTION

An anti-fouling composition has been developed that provides an advantageous reduction in the fouling of a structural part in a petroleum-refining system including reducing coking reactions and inhibiting deposition of solids in equipment and lines used for crude oil production and processing. The anti-fouling compositions contain a phosphate ester and a polyalkylene ester, polyolefin amide alkeneamine, polyethylene polyamine, or polyalkyleneimine.

### BACKGROUND OF THE INVENTION

Petrochemicals and their feedstocks typically are heated to temperatures from about 35° C. to about 550° C. during processing. Additionally, petroleum hydrocarbons used as heating fluids in heating and heat exchange systems are heated to similarly high temperatures. When heated to such high temperatures, fouling deposits can form in the petroleum hydrocarbon. The fouling deposits can then form deposits on the surfaces of the processing and heating equipment that foul the surfaces.

The fouling deposits can reduce the rate of heat transfer to the crude oil or other hydrocarbon streams, and over time, can reduce the rate of throughput of the heat exchanger or furnaces. If not addressed, the fouling of the equipment can progress and block the flow of crude oil through processing equipment and piping or clog filter screens, valves, and traps. Thus, the fouling of the surfaces can result in increased energy costs, increased capital costs (e.g., modification or replacement of equipment), and increased maintenance costs (e.g., cleaning or replacing screens, filters, pipes, valves, traps, and the like).

Although, the exact mechanism of fouling is not known, several different components of crude oil or hydrocarbon stream can contribute to fouling. For example, asphaltenes, polynuclear aromatic hydrocarbons, coke, organic polymers, organic reaction products, inorganic silicates inorganic salts, metal oxides, metal sulfides, and the like are believed to contribute to the complex nature of fouling deposits in petroleum processing. Additionally, metal oxides and metal sulfides are believed to contribute to fouling by accelerating the petroleum hydrocarbon oxidation rate by promoting degenerative chain branching and forming free radicals. The free radicals formed can then react by oxidizing and polymerizing components of the petroleum to form gum, polymeric materials, and sediments.

With the constraints of a relatively low viscosity (e.g., less than 500 centipoise) and high stability, a need still exists for effective anti-coke and anti-fouling compositions that inhibit (i.e., reduce or prevent) fouling of the structure parts of a petroleum-refining system exposed to a hydrocarbon fluid.

### BRIEF SUMMARY OF THE INVENTION

This disclosure is directed to an anti-fouling composition for inhibiting fouling of a structural part in a petroleum-refining system exposed to a hydrocarbon fluid. The anti-fouling composition comprises an effective amount of a phosphate ester; and an effective amount of a polyalkylene ester, polyolefin amide alkeneamine, polyethylene polyamine, or polyalkyleneimine.

The phosphate ester can comprise a monobasic phosphate ester, a dibasic phosphate ester, or a combination thereof. Preferably, the phosphate ester can comprise a mixture of a mono(alkyl) phosphate ester and a di(alkyl) phosphate ester; more preferably, the mono(alkyl) phosphate ester can comprise a mono(C₁-C₁₂ alkyl) phosphate ester and the di(alkyl) phosphate ester can comprise a di(C₁-C₁₂ alkyl) phosphate ester.

For the anti-fouling compositions described herein, the mono(alkyl) phosphate ester can comprise a mono(C₆-C₁₀ alkyl) phosphate ester and the di(alkyl) phosphate ester can comprise a di(C₆-C₁₀ alkyl) phosphate ester and preferably, the mono(alkyl) phosphate ester can comprise a mono(octyl) phosphate ester and the di(alkyl) phosphate ester can comprise a di(octyl) phosphate ester. Most preferably, the mono(alkyl) phosphate ester can comprise a mono(ethylhexyl) phosphate ester and the di(alkyl) phosphate ester can comprise a di(ethylhexyl) phosphate ester.

In the anti-fouling compositions described herein, the polyalkylene ester can comprise a polyalkylene succinic ester, a polyalkylene succinic anhydride, polyalkylene succinic acid, or a combination thereof. Preferably, the polyalkylene ester can comprise a polyethylene succinic ester, a polyethylene succinic anhydride, a polypropylene succinic ester, a polypropylene succinic anhydride, a polyisobutylene succinic ester, a polyisobutylene succinic anhydride, polyalkylene succinic acid, or a combination thereof. More preferably, the polyalkylene ester can comprise a polyisobutylene succinic ester.

In particular, the polyisobutylene succinic ester can be derived from a reaction of polyisobutylene succinic anhydride and a polyol.

The polyol used to prepare the polyisobutylene succinic ester can comprise pentaerythritol, triethanolamine, glycerol, glucose, sucrose, arabitol, erythritol, maltitol, mannitol, ribitol, sorbitol, xylitol, threitol, galactitol, isomalt, iditol, lactitol, or a combination thereof; preferably, the polyol can comprise pentaerythritol.

The anti-fouling compositions described herein can have the polyalkylene ester, polyolefin amide alkeneamine, polyethylene polyamine, or polyalkyleneimine be present at a concentration from about 1 wt. % to about 99 wt. %, and the phosphate ester be present at a concentration from about 1 wt. % to about 99 wt. %, based on the total weight of the phosphate ester and the polyalkylene ester, polyolefin amide alkeneamine, polyethylene polyamine, or polyalkyleneimine. Further, the anti-fouling compositions can have polyalkylene ester be present at a concentration from about 50 wt. % to about 90 wt. %, and the phosphate ester be present at a concentration from about 10 wt. % to about 50 wt. %, based on the total weight of the phosphate ester and the polyalkylene ester, polyolefin amide alkeneamine, polyethylene polyamine, or polyalkyleneimine.

Preferably, the anti-fouling compositions can have the polyalkylene ester be present at a concentration from about 65 wt. % to about 85 wt. %, and the phosphate ester be present at a concentration from about 25 wt. % to about 35 wt. %, based on the total weight of the polyalkylene ester and the phosphate ester.

A method for reducing or preventing fouling of a structural part in a petroleum-refining system exposed to a hydrocarbon fluid is also disclosed, the method comprises contacting the structural part with the anti-fouling composition described herein.

In the methods for reducing or preventing fouling of a structural part in a petroleum-refining system exposed to a hydrocarbon fluid, the hydrocarbon fluid can be a petrochemical fluid.

In the methods for reducing or preventing fouling of a structural part in a petroleum-refining system exposed to a hydrocarbon fluid, the petrochemical fluid can comprise an asphaltene, a paraffin, a wax, a scale, a naphthenate, coke, or a combination thereof.

In the disclosed methods, the anti-fouling composition can be contacted with the petrochemical fluid in an effective amount to disperse asphaltene.

In the disclosed methods, the anti-fouling composition can be contacted with the petrochemical fluid in an effective amount to prevent or reduce deposition of coke.

Additionally, in the disclosed methods, the anti-fouling composition can be contacted with the petrochemical fluid in an effective amount to prevent or reduce deposition of a foulant.

In the disclosed methods, the structural part in a petroleum-refining system can comprise a part of a storage unit, a heat exchanger, a pipe, a pump, a flow meter, a valve, a desalter, a furnace, a coker, a distillation column, a fractionation column, an atmospheric column, a pipe still, a debutanizer, a reactor, a fluid catalytic cracking unit, a fluid catalytic cracking slurry settler, a hydrocracking unit, a steam cracking unit, a thermal cracking unit, a visbreaker, a reflux unit, a condenser, a scrubber, or a combination thereof. Preferably, the structural part can comprise part of a fluid catalytic cracking unit, a fluid catalytic cracking slurry settler, a hydrocracking unit, a steam cracking unit, a thermal cracking unit, a visbreaker, or a combination thereof. More preferably, the structural part can comprise part of a fluid catalytic cracking unit, a visbreaker, or a combination thereof

In the methods for reducing or preventing fouling of a structural part in a petroleum-refining system exposed to a hydrocarbon fluid, the effective amount of the anti-fouling composition is from about 1 ppm to about 50,000 ppm, or from about 1 ppm to about 500 ppm of the anti-fouling composition based on the total amount of hydrocarbon fluid.

Other objects and features will be in part apparent and in part pointed out hereinafter.

### BRIEF DESCRIPTION OF THE SEVERAL VIEWS OF THE DRAWING

FIG. 1 shows a bar graph of the mass of the deposit in mg for each test and comparator composition.

FIG. 2 shows particle volume versus the particle size for each test and comparator composition.

FIG. 3 shows a bar graph of the total mass of coke formation in mg for each test and comparator composition.

Corresponding reference characters indicate corresponding parts throughout the drawings.

### DETAILED DESCRIPTION OF THE INVENTION

Anti-fouling compositions are disclosed that can be used in methods of inhibiting (e.g., reducing or preventing) fouling of a structural part in a petroleum-refining system exposed to a hydrocarbon fluid. The anti-fouling compositions reduce deposition of fouling compounds on the surfaces of the structural parts in a petroleum-refining system. Without being bound to a particular theory, it is believed that the components of the anti-fouling composition provide more than one mechanism of action with one component contacting the surface of the structural part and passivating the metal surface while another component of the composition disperses a component of the hydrocarbon fluid, in particular, the other component disperses asphaltenes/foulant precursors in the hydrocarbon fluid.

The anti-fouling compositions described herein can be used for inhibiting fouling of a structural part in a petroleum-refining system exposed to a hydrocarbon fluid. The anti-fouling composition comprises an effective amount of a phosphate ester and an effective amount of a polyalkylene ester, polyolefin amide alkeneamine, polyethylene polyamine, or polyalkyleneimine.

The phosphate ester can comprise a monobasic phosphate ester, a dibasic phosphate ester, or a combination thereof. Preferably, the phosphate ester can comprise a mixture of a mono(alkyl) phosphate ester and a di(alkyl) phosphate ester; more preferably, the mono(alkyl) phosphate ester can comprise a mono(C₁-C₁₂ alkyl) phosphate ester and the di(alkyl) phosphate ester can comprise a di(C₁-C₁₂ alkyl) phosphate ester.

For the anti-fouling compositions described herein, the mono(alkyl) phosphate ester can comprise a mono(C₆-C₁₀ alkyl) phosphate ester and the di(alkyl) phosphate ester can comprise a di(C₆-C₁₀ alkyl) phosphate ester and preferably, the mono(alkyl) phosphate ester can comprise a mono(octyl) phosphate ester and the di(alkyl) phosphate ester can comprise a di(octyl) phosphate ester. Most preferably, the mono(alkyl) phosphate ester can comprise a mono(ethylhexyl) phosphate ester and the di(alkyl) phosphate ester can comprise a di(ethylhexyl) phosphate ester.

Preferably, the anti-fouling composition comprises an effective amount of a phosphate ester and an effective amount of a polyalkylene ester. The polyalkylene ester can comprise a polyalkylene succinic ester, a polyalkylene succinic anhydride, polyalkylene succinic acid, or a combination thereof. Preferably, the polyalkylene ester can comprise a polyethylene succinic ester, a polyethylene succinic anhydride, a polypropylene succinic ester, a polypropylene succinic anhydride, a polyisobutylene succinic ester, a polyisobutylene succinic anhydride, polyalkylene succinic acid, or a combination thereof. More preferably, the polyalkylene ester can comprise a polyisobutylene succinic ester.

In particular, the polyisobutylene succinic ester can be derived from a reaction of polyisobutylene succinic anhydride and a polyol.

The polyol used to prepare the polyisobutylene succinic ester can comprise pentaerythritol, triethanolamine, glycerol, glucose, sucrose, arabitol, erythritol, maltitol, mannitol, ribitol, sorbitol, xylitol, threitol, galactitol, isomalt, iditol, lactitol, or a combination thereof; preferably, the polyol can comprise pentaerythritol.

Most preferably, the polyisobutylene succinic ester is derived from a reaction of polyisobutylene succinic anhydride and pentaerythritol.

The anti-fouling composition can further comprise a solvent. The solvent can be a hydrocarbon solvent. Preferably, the solvent comprises an aromatic solvent; most preferably, the solvent comprises heavy aromatic naphtha, xylene, toluene, or a combination thereof.

The anti-fouling compositions described herein can have the polyalkylene ester be present at a concentration from about 1 wt. % to about 99 wt. %, and the phosphate ester be present at a concentration from about 1 wt. % to about 99 wt. %, based on the total weight of the phosphate ester and the polyalkylene ester. Further, the anti-fouling compositions can have polyalkylene ester be present at a concentration from about 55 wt. % to about 85 wt. %, and the phosphate ester be present at a concentration from about 15 wt. % to about 45 wt. %, based on the total weight of the polyalkylene ester and the phosphate ester. Preferably, the anti-fouling compositions can have the polyalkylene ester be present at a concentration from about 65 wt. % to about 85 wt. %, and the phosphate ester be present at a concentration from about 25 wt. % to about 35 wt. %, based on the total weight of the polyalkylene ester and the phosphate ester.

Additionally, the anti-fouling compositions described herein can have the polyalkylene ester be present at a concentration from about 1 wt. % to about 99 wt. %, from about 1 wt. % to about 90 wt. %, from about 1 wt. % to about 85 wt. %, from about 1 wt. % to about 80 wt. %, from about 1 wt. % to about 75 wt. %, from about 20 wt. % to about 99 wt. %, from about 20 wt. % to about 90 wt. %, from about 20 wt. % to about 80 wt. %,. from about 20 wt. % to about 75 wt. %, from about 40 wt. % to about 99 wt. %, from about 40 wt. % to about 90 wt. %, from about 40 wt. % to about 80 wt. %, from about 40 wt. % to about 75 wt. %, from about 60 wt. % to about 99 wt. %, from about 60 wt. % to about 90 wt. %, from about 60 wt. % to about 80 wt. %, from about 60 wt. % to about 75 wt. %, from about 65 wt. % to about 99 wt. %, from about 65 wt. % to about 90 wt. %, from about 65 wt. % to about 80 wt. %, or from about 65 wt. % to about 75 wt. %. The concentration of the polyalkylene ester is based on the total weight of the phosphate ester and the polyalkylene ester.

The phosphate ester be present in the anti-fouling compositions at a concentration from about 1 wt. % to about 99 wt. %, from about 1 wt. % to about 75 wt. %, from about 1 wt. % to about 50 wt. %, from about 1 wt. % to about 40 wt. %, from about 1 wt. % to about 35 wt. %, from about 10 wt. % to about 99 wt. %, from about 10 wt. % to about 75 wt. %, from about 10 wt. % to about 50 wt. %, from about 10 wt. % to about 40 wt. %, from about 10 wt. % to about 35 wt. %, from about 20 wt. % to about 99 wt. %, from about 20 wt. % to about 75 wt. %, from about 20 wt. % to about 50 wt. %, from about 20 wt. % to about 40 wt. %, from about 20 wt. % to about 35 wt. %, from about 25 wt. % to about 99 wt. %, from about 25 wt. % to about 75 wt. %, from about 25 wt. % to about 50 wt. %, from about 25 wt. % to about 40 wt. %, or from about 25 wt. % to about 35 wt. %. The concentration of the phosphate ester is based on the total weight of the phosphate ester and the polyalkylene ester.

A method for reducing or preventing fouling of a structural part in a petroleum-refining system exposed to a hydrocarbon fluid is also disclosed, the method comprises contacting the structural part with the anti-fouling composition described herein.

In the methods for reducing or preventing fouling of a structural part in a petroleum-refining system exposed to a hydrocarbon fluid, the hydrocarbon fluid can be a petrochemical fluid.

In the methods for reducing or preventing fouling of a structural part in a petroleum-refining system exposed to a hydrocarbon fluid, the petrochemical fluid can comprise an asphaltene, a paraffin, a wax, a scale, a naphthenate, coke, or a combination thereof.

In the disclosed methods, the anti-fouling composition can be contacted with the petrochemical fluid in an effective amount to disperse asphaltene.

In the disclosed methods, the anti-fouling composition can be contacted with the petrochemical fluid in an effective amount to prevent or reduce deposition of coke.

Additionally, in the disclosed methods, the anti-fouling composition can be contacted with the petrochemical fluid in an effective amount to prevent or reduce deposition of a foulant.

In the disclosed methods, the structural part in a petroleum-refining system can comprise a part of a storage unit, a heat exchanger, a pipe, a pump, a flow meter, a valve, a desalter, a furnace, a coker, a distillation column, a fractionation column, an atmospheric column, a pipe still, a debutanizer, a reactor, a fluid catalytic cracking unit, a fluid catalytic cracking slurry settler, a hydrocracking unit, a steam cracking unit, a thermal cracking unit, a visbreaker, a reflex unit, a condenser, a scrubber, or a combination thereof. Preferably, the structural part can comprise part of a fluid catalytic cracking unit, a fluid catalytic cracking slurry settler, a hydrocracking unit, a steam cracking unit, a thermal cracking unit, a visbreaker, or a combination thereof. More preferably, the structural part can comprise part of a fluid catalytic cracking unit, a visbreaker, or a combination thereof

In the methods for reducing or preventing fouling of a structural part in a petroleum-refining system exposed to a hydrocarbon fluid, the effective amount of the anti-fouling composition is from about 1 ppm to about 50,000 ppm, or from about 1 ppm to about 500 ppm of the anti-fouling composition based on the total amount of hydrocarbon fluid

The anti-fouling composition can further consist essentially of a polyalkylene ester and a phosphate ester as described herein. The anti-fouling composition consisting essentially of these components has the novel properties of acceptable reduction or prevention of deposition of the foulants in the hydrocarbon fluid in contact with the structural parts in a petroleum-refining system exposed to the hydrocarbon fluid when used in the methods described herein.

In the methods for reducing or preventing deposition of a component of a crude oil, the effective amount of the anti-fouling composition is from about 1 ppm to about 50,000 ppm, from about 1 ppm to about 40,000 ppm, from about 1 ppm to about 30,000 ppm, from about 1 ppm to about 20,000 ppm, from about 1 ppm to about 10,000 ppm, from about 1 ppm to about 7,500 ppm, from about 1 ppm to about 5,000 ppm, from about 1 ppm to about 2,500 ppm, from about 1 ppm to about 2,000 ppm, from about 1 ppm to about 1,500 ppm, from about 1 ppm to about 1,000 ppm, from about 1 ppm to about 500 ppm, from about 1 ppm to about 100 ppm, from about 5 ppm to about 50,000 ppm, from about 5 ppm to about 40,000 ppm, from about 5 ppm to about 30,000 ppm, from about 5 ppm to about 20,000 ppm, from about 5 ppm to about 10,000 ppm, from about 5 ppm to about 7,500 ppm, from about 5 ppm to about 5,000 ppm, from about 5 ppm to about 2,500 ppm, from about 5 ppm to about 2,000 ppm, from about 5 ppm to about 1,500 ppm, from about 5 ppm to about 1,000 ppm, from about 5 ppm to about 500 ppm, or from about 5 ppm to about 100 ppm of the anti-fouling composition based on the total amount of hydrocarbon fluid.

### Definitions

The term “alkyl,” as used herein, refers to a linear or branched hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons). Alkyl groups include, but are not limited to, methyl, ethyl, n-propyl, isopropyl, n-butyl, iso-butyl, secondary-butyl, and tertiary-butyl. Alkyl groups may be unsubstituted or substituted by one or more suitable substituents, as defined above.

The term “alkenyl,” as used herein, refers to a straight or branched hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, and having one or more carbon-carbon double bonds. Alkenyl groups include, but are not limited to, ethenyl, 1-propenyl, 2-propenyl (allyl), iso-propenyl, 2-methyl-1-propenyl, 1-butenyl, and 2-butenyl. Alkenyl groups may be unsubstituted or substituted by one or more suitable substituents, as defined above.

The term “alkynyl,” as used herein, refers to a straight or branched hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, and having one or more carbon-carbon triple bonds. Alkynyl groups include, but are not limited to, ethynyl, propynyl, and butynyl. Alkynyl groups may be unsubstituted or substituted by one or more suitable substituents, as defined above.

The term “alkoxy,” as used herein, refers to an alkyl group, as defined herein, appended to the parent molecular moiety through an oxygen atom.

The term “aryl,” as used herein, means monocyclic, bicyclic, or tricyclic aromatic radicals such as phenyl, naphthyl, tetrahydronaphthyl, indanyl and the like; optionally substituted by one or more suitable substituents, preferably 1 to 5 suitable substituents, as defined above.

The term “arylalkyl,” as used herein, refers to an aryl group attached to the parent molecular moiety through an alkyl group. Arylalkyl groups may be unsubstituted or substituted by one or more suitable substituents, as defined above.

The term “cycloalkyl,” as used herein, refers to a mono, bicyclic or tricyclic carbocyclic radical (e.g., cyclopropyl, cyclobutyl, cyclopentyl, cyclohexyl, cycloheptyl, cyclooctyl, cyclononyl, cyclopentenyl, cyclohexenyl, bicyclo[2.2.1]heptanyl, bicyclo[3.2.1]octanyl and bicyclo[5.2.0]nonanyl, etc.); optionally containing 1 or 2 double bonds. Cycloalkyl groups may be unsubstituted or substituted by one or more suitable substituents, preferably 1 to 5 suitable substituents, as defined above.

The term “halo” or “halogen,” as used herein, refers to a fluoro, chloro, bromo or iodo radical.

The term “heteroaryl,” as used herein, refers to a monocyclic, bicyclic, or tricyclic aromatic heterocyclic group containing one or more heteroatoms (e.g., 1 to 3 heteroatoms) selected from 0, S and N in the ring(s). Heteroaryl groups include, but are not limited to, pyridyl, pyrazinyl, pyrimidinyl, pyridazinyl, thienyl, furyl, imidazolyl, pyrrolyl, oxazolyl (e.g., 1,3-oxazolyl, 1,2-oxazolyl), thiazolyl (e.g., 1,2-thiazolyl, 1,3-thiazolyl), pyrazolyl, tetrazolyl, triazolyl (e.g., 1,2,3-triazolyl, 1,2,4-triazolyl), oxadiazolyl (e.g., 1,2,3-oxadiazolyl), thiadiazolyl (e.g., 1,3,4-thiadiazolyl), quinolyl, isoquinolyl, benzothienyl, benzofuryl, and indolyl. Heteroaryl groups may be unsubstituted or substituted by one or more suitable substituents, preferably 1 to 5 suitable substituents, as defined above.

The term “heterocycle” or “heterocyclyl,” as used herein, refers to a monocyclic, bicyclic, or tricyclic group containing 1 to 4 heteroatoms selected from N, O, S(O)n, P(O)n, PRz, NH or NRz, wherein Rz is a suitable substituent. Heterocyclic groups optionally contain 1 or 2 double bonds. Heterocyclic groups include, but are not limited to, azetidinyl, tetrahydrofuranyl, imidazolidinyl, pyrrolidinyl, piperidinyl, piperazinyl, oxazolidinyl, thiazolidinyl, pyrazolidinyl, thiomorpholinyl, tetrahydrothiazinyl, tetrahydro-thiadiazinyl, morpholinyl, oxetanyl, tetrahydrodiazinyl, oxazinyl, oxathiazinyl, indolinyl, isoindolinyl, quinuclidinyl, chromanyl, isochromanyl, and benzoxazinyl. Examples of monocyclic saturated or partially saturated ring systems are tetrahydrofuran-2-yl, tetrahydrofuran-3-yl, imidazolidin-1-yl, imidazolidin-2-yl, imidazolidin-4-yl, pyrrolidin-1-yl, pyrrolidin-2-yl, pyrrolidin-3-yl, piperidin-1-yl, piperidin-2-yl, piperidin-3-yl, piperazin-1-yl, piperazin-2-yl, piperazin-3-yl, 1,3-oxazolidin-3-yl, isothiazolidine, 1,3-thiazolidin-3-yl, 1,2-pyrazolidin-2-yl, 1,3-pyrazolidin-1-yl, thiomorpholin-yl, 1,2-tetrahydrothiazin-2-yl, 1,3-tetrahydrothiazin-3-yl, tetrahydrothiadiazin-yl, morpholin-yl, 1,2-tetrahydrodiazin-2-yl, 1,3-tetrahydrodiazin-1-yl, 1,4-oxazin-2-yl, and 1,2,5-oxathiazin-4-yl. Heterocyclic groups may be unsubstituted or substituted by one or more suitable substituents, preferably 1 to 3 suitable substituents, as defined above.

The term “hydroxy,” as used herein, refers to an —OH group.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Having described the invention in detail, it will be apparent that modifications and variations are possible without departing from the scope of the invention defined in the appended claims.

### EXAMPLES

The following non-limiting examples are provided to further illustrate the present invention.

The foulant formation inhibition ability of the disclosed invention was evaluated using Nalco Champion's Pyrolysis Simulation Unit (PSU). The foulant deposition amount was determined by measuring the weight gain on SS304 meshes when the foulants formed deposits.

TABLE
Experimental Parameters used in
High Temperature Fouling Testing

| Experimental Variable | Parameter | |
|---|---|---|
| Temperature | 410° | C. |
| Shear Rate | 440 rpm after the temperature reaches | |
| | 410° | C. |
| Reaction N₂ Pressure | 8 bar @ at room temperature | |
| Time | 60 | minutes |
| Autoclave Testing Medium | FCC Slurry | |
| Anticoke dose | 600 | ppm |

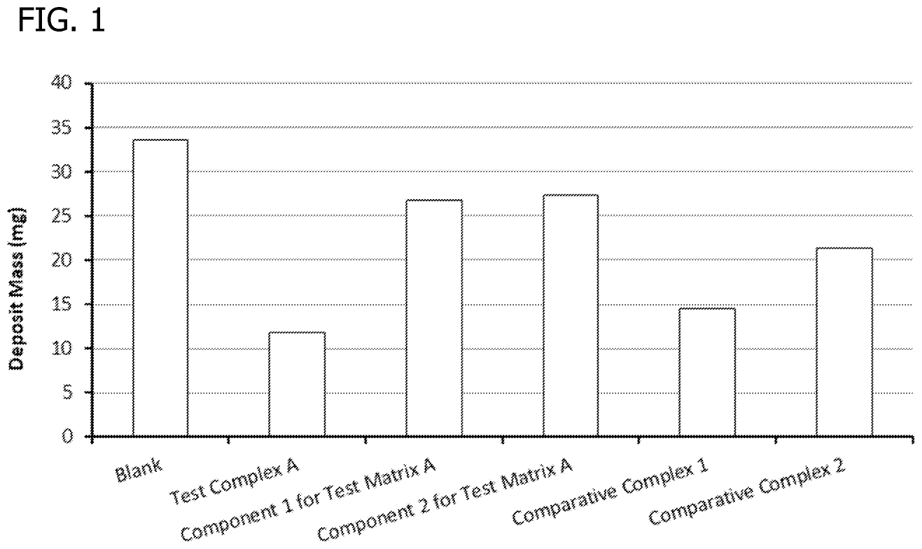

A fluid catalytic cracking (FCC) unit slurry sample was pyrolyzed at the conditions given in the table above. The foulant deposition on the surface of the PSU was measured by gravimetric analysis. FIG. 1 shows a comparison of the anticoke effectiveness of the new formulation (labelled Test Complex A or Test Matrix A) against two comparator compositions (labelled Comparative Complex 1 and 2). The x-axis shows the additives that were used in the tests. “Blank” test implies that there was no additive, only the FCC slurry was pyrolyzed. The results show that the anti-coke deposition performance of the Test Complex A surpasses that of two comparator compositions.

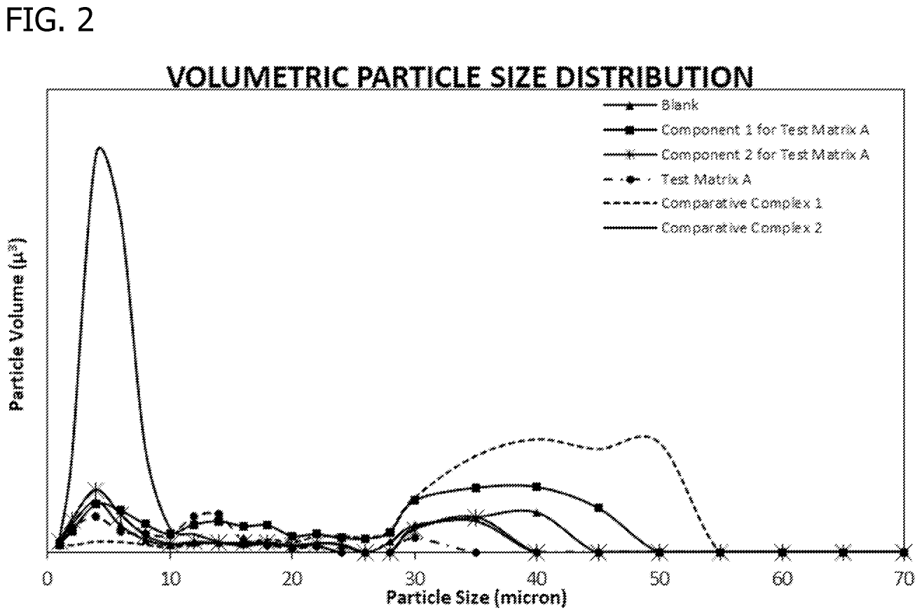

Particle size distribution analysis was performed on the pyrolyzed slurry sample. FIG. 2 shows the particulate volume versus the particle size distribution. The Test Matrix A (the new formulation) minimized the size of the particles (e.g., reduced particulate growth).

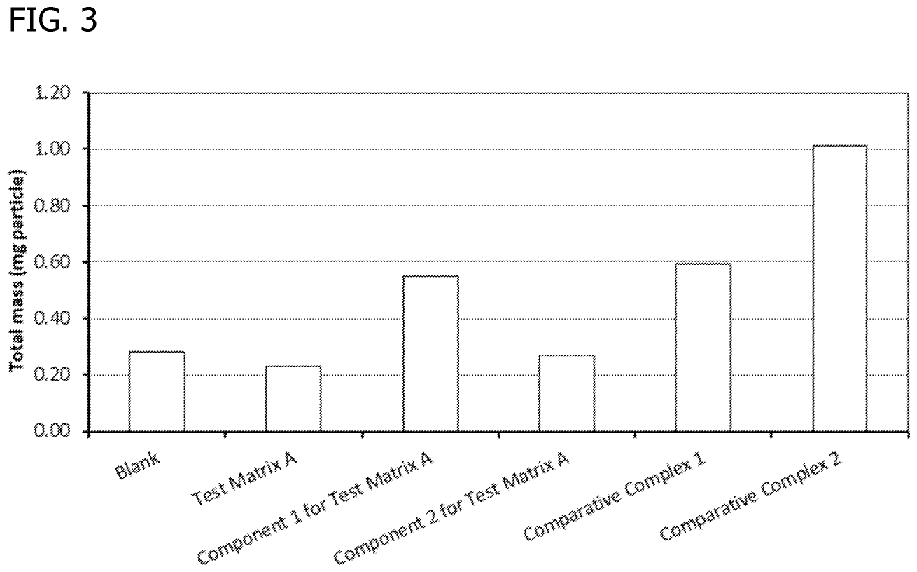

The total coke formation in the bulk liquid was calculated using the particle size distribution analysis results. FIG. 3 shows the total coke amounts in the bulk liquid. In parallel to the FIG. 2 results, the Test Matrix A (the new formulation) minimized the total coke/particulate formation in the pyrolyzed slurry.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and methods without departing from the scope of the invention, it is intended that all matter contained in the above description and shown in the accompanying drawings shall be interpreted as illustrative and not in a limiting sense.

1. An anti-fouling composition for inhibiting fouling of a structural part in a petroleum-refining system exposed to a hydrocarbon fluid, the anti-fouling composition comprising:
an effective amount of a phosphate ester; and
an effective amount of a polyalkylene ester, polyolefin amide alkeneamine, polyethylene polyamine, or polyalkyleneimine.

2. The anti-fouling composition of claim 1, wherein the phosphate ester comprises a monobasic phosphate ester, a dibasic phosphate ester, or a combination thereof.

3. The anti-fouling composition of claim 1 or 2, wherein the phosphate ester comprises a mixture of a mono(alkyl) phosphate ester and a di(alkyl) phosphate ester.

4. The anti-fouling composition of claim 3, wherein the mono(alkyl) phosphate ester comprises a mono(C₁-C₁₂ alkyl) phosphate ester and the di(alkyl) phosphate ester comprises a di(C₁-C₁₂ alkyl) phosphate ester.

5. (canceled)

6. The anti-fouling composition of claim 3, wherein the mono(alkyl) phosphate ester comprises a mono(C₆-C₁₀ alkyl) phosphate ester and the di(alkyl) phosphate ester comprises a di(C₆-C₁₀ alkyl) phosphate ester.

7. The anti-fouling composition of claim 3, wherein the mono(alkyl) phosphate ester comprises a mono(octyl) phosphate ester and the di(alkyl) phosphate ester comprises a di(octyl) phosphate ester.

8. The anti-fouling composition of claim 3, wherein the mono(alkyl) phosphate ester comprises a mono(ethylhexyl) phosphate ester and the di(alkyl) phosphate ester comprises a di(ethylhexyl) phosphate ester.

9. The anti-fouling composition of claim 1, comprising a polyalkylene ester, wherein the polyalkylene ester comprises a polyalkylene succinic ester, a polyalkylene succinic anhydride, polyalkylene succinic acid, or a combination thereof.

10. The anti-fouling composition of claim 9, wherein the polyalkylene ester comprises a polyethylene succinic ester, a polyethylene succinic anhydride, a polypropylene succinic ester, a polypropylene succinic anhydride, a polyisobutylene succinic ester, a polyisobutylene succinic anhydride, polyalkylene succinic acid, or a combination thereof.

11. The anti-fouling composition of claim 9, wherein the polyalkylene ester comprises a polyisobutylene succinic ester.

12. The anti-fouling composition of claim 11, wherein the polyisobutylene succinic ester is derived from a reaction of polyisobutylene succinic anhydride and a polyol.

13. The anti-fouling composition of claim 12, wherein the polyol comprises pentaerythritol, triethanolamine, glycerol, glucose, sucrose, arabitol, erythritol, maltitol, mannitol, ribitol, sorbitol, xylitol, threitol, galactitol, isomalt, iditol, lactitol, or a combination thereof.

14. The anti-fouling composition of claim 12, wherein the polyol comprises pentaerythritol.

15. (canceled)

16. The anti-fouling composition of claim 1, wherein the polyalkylene ester is present at a concentration from about 50 wt. % to about 90 wt. %, and the phosphate ester is present at a concentration from about 10 wt. % to about 50 wt. %, based on the total weight of the polyalkylene ester and the phosphate ester.

17. A method for reducing or preventing fouling of a structural part in a petroleum-refining system exposed to a hydrocarbon fluid, comprising contacting the structural part with an effective amount of the anti-fouling composition of claim 1.

18. The method of claim 17, wherein the hydrocarbon fluid is a petrochemical fluid and the petrochemical fluid comprises an asphaltene, a paraffin, a wax, a scale, a naphthenate, coke, or a combination thereof.

19. (canceled)

20. The method of claim 18, wherein the anti-fouling composition is contacted with the petrochemical fluid in an effective amount to disperse asphaltene.

21. The method of claim 20, wherein the anti-fouling composition is contacted with the structural part in an effective amount to prevent or reduce deposition of coke.

22. The method of claim 17, wherein the structural part comprises part of a storage unit, a heat exchanger, a pipe, a pump, a flow meter, a valve, a desalter, a furnace, a coker, a distillation column, a fractionation column, an atmospheric column, a pipe still, a debutanizer, a reactor, a fluid catalytic cracking unit, a fluid catalytic cracking slurry settler, a hydrocracking unit, a steam cracking unit, a thermal cracking unit, a visbreaker, a reflex unit, a condenser, a scrubber, or a combination thereof.

23.-25. (canceled)

26. The method of claim 17, wherein the effective amount of the anti-fouling composition is from about 1 ppm to about 500 ppm based on the total amount of hydrocarbon fluid.
